(19) United States
(12) Patent Application Publication
(10) Pub. No.: US 2026/0233253 A1
(43) Pub. Date: Aug. 13, 2026

(54) METHOD FOR CLEANING BULK MATERIAL, AND SEPARATING DEVICE

(71) Applicant: WITTMANN TECHNOLOGY GMBH, Wien (AT)

(72) Inventor: Erhard FUX, Michelhausen (AT)

(21) Appl. No.: 19/155,420

(22) PCT Filed: Apr. 12, 2024
(86) PCT No.: PCT/AT2024/060141

§ 371 Date: Aug. 11, 2025

(30) Foreign Application Priority Data
Apr. 14, 2023 (AT) GM 50060/2023

(51) Int. Cl. B07B 11/06; B07B 4/00; B07B 7/01; B07B 7/06; B07B 9/00; B29B 17/02

(52) U.S. Cl. CPC B07B 11/06; B07B 4/00; B07B 7/01; B07B 7/06; B07B 9/00; B29B 17/02; B29B 2017/0203; B29B 2017/0224; B29B 2017/0241

(57) ABSTRACT

The invention relates to a method for cleaning contaminated bulk material in a separating device with a cleaning chamber, comprising the following steps: suctioning the bulk material via an inlet nozzle, thereby conveying the bulk material into an inlet region during a conveying sequence; and discharging the cleaned bulk material through an outlet opening during an emptying sequence. The bulk material is conveyed from the inlet region into a circulating region of the cleaning chamber via suctioning during the conveying sequence and is continuously circulated in the circulating region via suctioning and is thereby cleaned. Contaminants are suctioned off from the circulating region via suctioning of the bulk material via a suctioning-off opening during the conveying sequence. The invention further relates to a separating device.

### CROSS REFERENCE TO RELATED APPLICATIONS

The present application is a U.S. National Phase of International Application No. PCT/AT2024/060141 entitled “METHOD FOR CLEANING BULK MATERIAL, AND SEPARATING DEVICE,” and filed on Apr. 12, 2024. International Application No. PCT/AT2024/060141 claims priority to Austrian Patent Application No. GM 50060/2023 filed on Apr. 14, 2023. The entire contents of each of the above-listed applications are hereby incorporated by reference for all purposes.

### TECHNICAL FIELD

The invention relates to a method for cleaning contaminated bulk material, preferably plastic bulk material, in particular recyclate, in a separating device with a cleaning chamber, comprising the following steps:
i) suctioning the contaminated bulk material via an inlet nozzle of the separating device and thereby conveying the contaminated bulk material into a preferably at least partially conically shaped inlet region of the cleaning chamber during a conveying sequence;
ii) suctioning a fluid, in particular air, through the inlet nozzle during an optional empty suction sequence following the conveying sequence, in particular to empty the inlet nozzle and a suction line of possible residues of the contaminated bulk material, wherein the conveying sequence and preferably the optional empty suction sequence form a conveying phase; and
iii) discharging the cleaned bulk material through an outlet opening during an emptying sequence after completion of the conveying phase.

Furthermore, the invention relates to a separating device for cleaning contaminated bulk material, comprising:
a cleaning chamber having a preferably at least partially conically shaped inlet region;
an inlet nozzle leading into the inlet region; and
an outlet opening preferably closable by a flap,
wherein the separating device is configured to be operated in a conveying sequence in which the contaminated bulk material is conveyed through the inlet nozzle into the inlet region via suctioning, in an optional empty suction sequence in which a fluid, in particular air, is suctioned through the inlet nozzle, and in an emptying sequence in which cleaned bulk material is discharged through the outlet opening, wherein the conveying sequence and preferably the optional empty suction sequence form a conveying phase,

### BACKGROUND AND SUMMARY

In the production of plastic products, recycled plastic material is increasingly being used, but it may be contaminated by dust and fines. The contamination can occur, among other things, when cutting the recycled plastic material in cutting mills. The dust and fines can lead to quality problems in the production of plastic products. For example, coking may occur during melting of the plastic material. In addition, fines in the plastic material exhibit a different melting behavior than the actual plastic material, which results in an irregular distribution in the plastic melt and some streaks can be seen in the finished plastic product. Before the recycled plastic material can be further processed by plastic processing machines, it must therefore be cleaned to comply with quality specifications.

Material separators of the type mentioned at the outset are known from the prior art, in which a suctioning-off module suctions off dust and fines from a plastic material flowing past over a short distance of typically less than 300 mm. After the plastic material has passed the suctioning-off module, the plastic material ends up in a container. Due to the relatively short distance along which contaminants of the plastic material flowing past are suctioned off, the plastic material is not completely cleaned and still has high proportions of dust and fines. In order to achieve a higher degree of cleaning, the process would have to be repeated several times, which can lead to an increased effort or lower material throughput, especially in tightly timed manufacturing processes.

In the light of these statements, it is the object of the present invention to at least partially alleviate the disadvantages of the prior art. It is preferably the object of the present invention to provide a method and a separating device of the type mentioned at the outset, with which improved cleaning of bulk material is made possible. Preferably, the time for cleaning the bulk material should not be extended.

This object is achieved by a method for cleaning contaminated bulk material and by a separating device as described herein. The present disclosure further relates to a method for producing a plastic product and a system for producing a plastic product.

According to the invention, in a method of the type mentioned at the outset, it is provided that the contaminated bulk material is conveyed from the inlet region into a preferably at least partially conically shaped circulating region of the cleaning chamber via suctioning during the conveying phase and is continuously circulated in the circulating region up to the emptying sequence via suctioning and is thereby cleaned, wherein contaminants which detach from the contaminated bulk material are suctioned off from the circulating region via suctioning of the contaminated bulk material via a suctioning-off opening during the conveying phase. Advantageously, as a result of the continuous circulation during the conveying sequence and the optional empty suction sequence, the bulk material in the circulating region is thoroughly cleaned without extending the overall duration of the cleaning cycle, consisting of the conveying sequence, the optional empty suction sequence, and the emptying sequence. As a result, the method and the separating device can be integrated into an existing system without having to make complex adjustments. The circulation takes place by suctioning the bulk material. The bulk material is preferably suctioned by generating a vacuum or a negative pressure. In one embodiment, the optional suctioning of the fluid can also take place by means of a vacuum or by means of a negative pressure. Due to the circulation, dust and fine particles can be better separated from the bulk material to be cleaned and then suctioned off. In contrast to the prior art, the bulk material is cleaned during the entire conveying phase and thus over a longer period of time. Bulk material conveyed into the separating device therefore does not simply remain in place, while further material flows in the conveying sequence or a fluid, in particular air, is suctioned in the optional empty suction sequence, but is constantly circulated up to the emptying sequence and thus cleaned of dust and fine particles. The conveying sequence, the optional empty suction sequence and the emptying sequence together form a cleaning cycle within which a certain amount of bulk material is cleaned and discharged. The bulk material is preferably a plastic bulk material, in particular recycled plastic bulk material, also referred to as recyclate. The plastic bulk material may consist, for example, of petroleum-based polymers or biopolymers. The bulk material can be present, for example, in the form of granules, grains, shreds, pieces of film or powder. The separating device has a cleaning chamber into which the bulk material is sucked and in which the bulk material is subsequently cleaned. Preferably, the cleaning chamber is designed to be substantially rotationally symmetrical. The cleaning chamber may comprise a cylindrical almond-shaped outer wall, at least in sections. The inlet region and the circulating region are arranged within the cleaning chamber. The circulating region and the inlet region can be spatially separated from one another, for example by a wall. A plurality of circulating regions and/or inlet regions may also be provided. If a plurality of circulating regions and/or inlet regions are provided, these may likewise be spatially separated from one another, for example by a wall. The cleaning chamber may be made at least partially of transparent material in order to be able to see into the inlet region and the circulating region. The circulating region is preferably arranged at least partially above the inlet region. The circulating region may have a volume of 1 L to 80 L, for example. The inlet region may, for example, have a volume of 0.5 L to 20 L. In step i), the contaminated bulk material is suctioned via an inlet nozzle of the separating device during the conveying sequence and is thereby conveyed into an inlet region of the cleaning chamber. Suctioning is achieved by generating a negative pressure. The bulk material may be contaminated, for example, with finely divided, in particular fine-grained, or pulverulent particles. In the conveying phase, mainly bulk material, but also fluid, in particular air, is suctioned. The inlet region may be at least partially conically shaped. The contaminated bulk material may be stored in a reservoir outside the cleaning chamber and can be suctioned from there, for example, via a suction line, in particular a pipe or a tube. A metering device, for example, a flap or a valve, may be configured to release only a certain amount of accumulated contaminated bulk material in the conveying sequence for suction into the inlet region. The inlet nozzle may, for example, be arranged parallel or at right angles to a tangential circumferential direction of the cleaning chamber. In general, the inlet nozzle may be arranged at any angle to the outer wall of the cleaning chamber as long as the supply of bulk material is enabled. In the inlet region, the suctioned contaminated bulk material can be at least partially separated by swirling. Preferably, the inlet region is at least partially conically shaped in order to direct the flow of the contaminated bulk material. Due to an at least partially conical shape, the bulk material can be guided along the inner wall of the inlet region and can be partially swirled and braked, as a result of which first dust and fine particles can dissolve. In order to clear the inlet nozzle and the suction line of any remaining bulk material so that it does not fall back and lead to blockages in the suction line or the suction nozzle, it is optionally provided in step ii) that a fluid, in particular air, is suctioned during an optional empty suction sequence following the conveying sequence. In the empty suction sequence, no new bulk material is removed or suctioned from the reservoir of the contaminated bulk material, but at most only residues in the suction line or in the suction nozzle are also conveyed into the inlet region by suctioning the fluid. Ambient air, in particular, can serve as the suctioned fluid. According to the invention, during the conveying sequence and preferably the optional empty suction sequence, which together form the conveying phase, the contaminated bulk material is suctioning and thereby conveyed from the inlet region into a circulating region of the cleaning chamber. If no empty suction sequence is provided, the conveying phase is formed solely by the conveying sequence. An empty suction sequence can be dispensed with, for example, in the case of short lengths of the suction line. The circulating region may be at least partially conically shaped. Bulk material can already enter the circulating region in the conveying sequence. At the latest in the optional empty suction sequence, the majority of the bulk material is sucked into the circulating region. By suctioning fluid in the conveying phase, substantially all of the bulk material located in the inlet region is conveyed into the circulating region. Only small residues can occasionally remain in the inlet region. During the conveying phase, the bulk material is continuously circulated and thus cleaned within the circulating region via suctioning. The circulation preferably takes place by means of an upwardly directed suction fluid flow, which draws the bulk material upwards, from where it is displaced by subsequent bulk material and falls downwards again. The circulation dissolves dust and fine particles, which can be suctioned off. So that no bulk material is suctioned off with the dissolved contaminants, a grid, preferably a wire sieve, in particular an exchangeable wire sieve, may be provided, the opening width of the wire sieve being smaller than, for example, the smallest granulate size suitable for subsequent plasticization. The opening width defines the boundary between bulk material and dust or fine particles. The opening width refers to the maximum diameter of a grid opening. The strength of the suction fluid flow may be selected in such a way that the bulk material is not sucked onto the grid the entire time up to the emptying sequence and is no longer detached. The suction fluid flow may be a substantially constant fluid flow, for example a fluid flow with a strength between 50 m³/h and 400 m³/h, preferably between 100 m³/h and 300 m³/h, in an example of substantially 200 m³/h. The strength of the suction fluid flow may depend on, among other things, the type of bulk material and the length and cross-section of the suction line. While the bulk material is being circulated, contaminants that become detached from the contaminated bulk material are suctioned off. The suctioning of the bulk material or suctioning off of the contaminants is preferably carried out by the same suction device, which can be connected in particular in the circulating region. The suctioning or suctioning off creates a fluid flow from the suction nozzle and a possibly connected suction line via the inlet region into the circulating region and out of it to the suction device. In step iii), the conveying phase, consisting of the conveying sequence and preferably the optional empty suction phase, is ended by completely deactivating or reducing the suctioning and suctioning off, and the emptying sequence is started, in which the cleaned bulk material is discharged through an outlet opening. The cleaned bulk material can, for example, be fed directly or indirectly via a further process step or further cleaning to a plastic processing machine, such as an injection moulding machine or extrusion system. The outlet opening may be closable. Upon completion of the emptying sequence, the cleaning cycle may be restarted by suctioning freshly accumulated bulk material from the reservoir in the conveying sequence. Steps i-iii) are preferably carried out in the order indicated. The empty suction sequence may, for example, last between 0 s and 180 s. The conveying sequence may, for example, last between 1 s and 120 s. The emptying sequence may, for example, last between 1 s and 30 s.

Direction and location information in this disclosure refers to the intended state of use of the cleaning chamber. The circulating region is preferably arranged at least partially above the inlet region.

It is preferred if the suctioning-off opening is provided on an upper side of the cleaning chamber and a suction device is connected to the suctioning-off opening, the suctioning-off device suctioning the bulk material during the conveying phase and suctioning off the contaminants. The suctioning-off opening is preferably arranged on the upper side of the circulating region, so that an upwardly directed fluid flow is produced in the conveying sequence and the optional empty suction sequence in the circulating region. The suctioning-off device may be formed, for example, by a compressor. Suctioned off contaminants may be collected, for example, in a container or a bag.

In one embodiment of the invention, it may be provided that the outlet opening is arranged on an underside of the cleaning chamber and the cleaned bulk material falls downwards through the outlet opening due to gravity in the emptying sequence, preferably wherein the outlet opening can be closed by a flap in the conveying phase. In particular, the outlet opening may be arranged on the underside of the inlet region. In the emptying sequence, the suctioning is deactivated or reduced to such an extent that the cleaned bulk material falls down through the outlet opening due to gravity. The optional flap may be opened for this purpose. It is preferred if the flap is closed, in particular substantially closed in an airtight manner, during the conveying phase.

It is favorable if the contaminated bulk material is braked in the inlet region by the inner wall of the inlet region after suctioning in the conveying sequence, preferably wherein the bulk material moves substantially in the manner of a downwardly or upwardly tapering screw thread. The contact of the bulk material with the inner wall of the inlet region brakes the bulk material by friction and shakes it through, as a result of which the first contaminants may dissolve. Due to a tapering shape of the inlet region, the bulk material may be moved in the manner of a downwardly or upwardly tapering screw thread, as a result of which the bulk material may be transferred in a targeted manner into the circulating region.

In one embodiment of the invention, the circulating region comprises an inlet opening, in particular on the underside, which is preferably arranged below the inlet nozzle, so that the bulk material is initially preferably sucked downwards to the inlet opening in the conveying phase in the inlet region and is then sucked in particular upwards into the circulating region. The inlet opening may also be arranged laterally on the circulating region. However, if the inlet opening is arranged on the underside, this has the advantage that cleaned bulk material may simply fall down in the emptying sequence and thus more easily get out of the circulating region.

It is particularly preferred if the contaminated bulk material is circulated in the circulating region by the contaminated bulk material being suctioned from above, being displaced radially outwards by subsequent contaminated bulk material, falling downwards and then being suctioned again from above. For this purpose, the suction device may be connected to an upper side of the circulating region.

In order to clean a large amount of bulk material, it is advantageous if the conveying phase and the emptying sequence form a cleaning cycle and a plurality of cleaning cycles are carried out in succession. In each cleaning cycle, new, contaminated bulk material may be suctioned from a reservoir. The cleaning cycles may all have the same duration.

In order to clean contaminated bulk material, at least one further separating device may be provided, which is connected in parallel with the separating device and also cleans contaminated bulk material according to steps i)-iii) as described above using the method according to the invention. The further separating device may be constructed in the same manner, in particular identically, to the separating device. The further separating device may perform the same method as the separating device.

The invention also provides a method for producing a plastic product, comprising the following steps:
a) cleaning contaminated bulk material with a method for cleaning contaminated bulk material as described above;
b) feeding the cleaned bulk material to a plastic processing machine, in particular an injection moulding machine or extrusion system;
c) producing a plastic product with the plastic processing machine.

After cleaning the contaminated bulk material, intermediate storage, a further process step or further cleaning may be provided. The plastic product may be, for example, a part for the interior of an automobile, a packaging container, a toy, or a window profile.

The object according to the invention is also achieved by a separating device of the type mentioned at the beginning, in which it is provided that the cleaning chamber comprises a preferably at least partially conically shaped circulating region and the inlet region and the circulating region are arranged and designed in such a way that the contaminated bulk material is conveyed from the inlet region into the circulating region via suctioning during the conveying phase during operation of the separating device and is continuously circulated in the circulating region up to the emptying sequence via suctioning and is thereby cleaned, wherein contaminants which detach from the contaminated bulk material can be suctioned off from the circulating region via suctioning the contaminated bulk material via an suctioning-off opening during the conveying phase. The separating device according to the invention is preferably designed to carry out the above-described method for cleaning contaminated bulk material. The advantages and features described in connection with the method for cleaning contaminated bulk material can therefore be transferred to the separating device according to the invention. In particular, the inlet region and the circulating region may be spatially separated from one another by a wall. The separating device is preferably designed as a vacuum conveyor separating device. The separating device preferably comprises a device for generating a vacuum or a negative pressure or is connected to such a device, for example. With the aid of the vacuum or negative pressure, the bulk material or optionally the fluid may be conveyed through the separating device.

In one embodiment of the invention, it is provided that the suctioning-off opening is arranged on an upper side of the cleaning chamber, in particular on an upper side of the circulating region, and is designed as a connection for a suctioning-off device. The suctioning-off device may be connected to the suctioning-off opening by means of a tube or a pipe. Alternatively, the suctioning-off device may be directly connected to the suctioning-off opening.

In order to prevent the bulk material from being suctioned off, a grid may be provided in the circulating region, preferably on an upper side of the circulating region. In particular, the grid may be arranged horizontally in the circulating region. Depending on the design of the separating device, other arrangements of the grid, such as an oblique or vertical arrangement, are also possible. The grid preferably extends substantially over the entire cross-sectional area of the circulating region. The grid may be a wire sieve. Preferably, the grid is designed to be replaceable.

The grid may, for example, have an opening width of 0.2 mm to 5 mm, in particular 0.5 mm to 3 mm.

In one embodiment of the invention, it can be provided that the circulating region preferably comprises an inlet opening on the underside, through which the contaminated bulk material passes into the circulating region, the inlet opening being arranged in particular below the inlet nozzle. By arranging the inlet opening on the underside, cleaned bulk material can advantageously be conveyed out of the circulating region in the emptying sequence due to gravity.

It is preferred that the circulating region is adjoined by an inlet tube, which comprises an inlet opening arranged at the end of the inlet tube, facing the underside of the cleaning chamber. The inlet tube may have a length of 40 mm to 550 mm, for example. The inlet tube may have a diameter of 30 mm to 80 mm, for example. The inlet tube preferably has a round cross-section.

It has proven particularly favorable if the cross-sectional area of the inlet opening is between 50% and 130%, preferably between 60% and 120%, of the cross-sectional area of the inlet nozzle. Alternatively, it may be provided that the cross-sectional area of the inlet opening substantially corresponds to the cross-sectional area of the inlet nozzle.

In order to make it easier for bulk material to enter the circulating region, it can be provided that, viewed in the cross-section of the cleaning chamber and along a longitudinal axis of the cleaning chamber, the inlet region and the circulating region at least partially overlap. In other words, there is a section along the longitudinal axis of the cleaning chamber in which both the inlet region and the circulating region are arranged.

To guide the flow of material and fluid, it is advantageous if, viewed in the cross-section of the cleaning chamber, the inlet region and the circulating region each comprise a conically converging section, and a channel for the contaminated bulk material is formed in the inlet region between the conically converging sections of the inlet region and the circulating region. The conically converging section of the circulating region promotes the circulation of the bulk material.

In one embodiment of the invention, it is provided that, viewed in the cross-section of the cleaning chamber, the inlet nozzle is arranged at the level of the conically converging section of the circulating region. As a result, the flow of the contaminated bulk material is advantageously conducted into the inlet region.

The invention also provides a system for producing a plastic product, comprising the following:
a suction device;
a separating device, as described above, connected to the suction device;
a plastic processing machine, in particular an injection moulding machine or extrusion system, which is connected to the separating device.

The transport of the contaminated bulk material to the separating device and from the separating device to the plastic processing machine can take place in particular via hoses or pipes. The plastic processing machine may, for example, produce parts for the interior of an automobile, packaging containers, toys, or window profiles.

The invention is described below on the basis of a specific exemplary embodiment, to which, however, it is not intended to be limited.

### BRIEF DESCRIPTION OF THE FIGURES

The drawings show the following:

FIG. 1 shows a separating device in cross-section;

FIG. 2 shows a cross-sectional view of the separating device in a conveying phase; and

FIG. 3 shows a cross-sectional view of the separating device in an emptying sequence.

### DETAILED DESCRIPTION

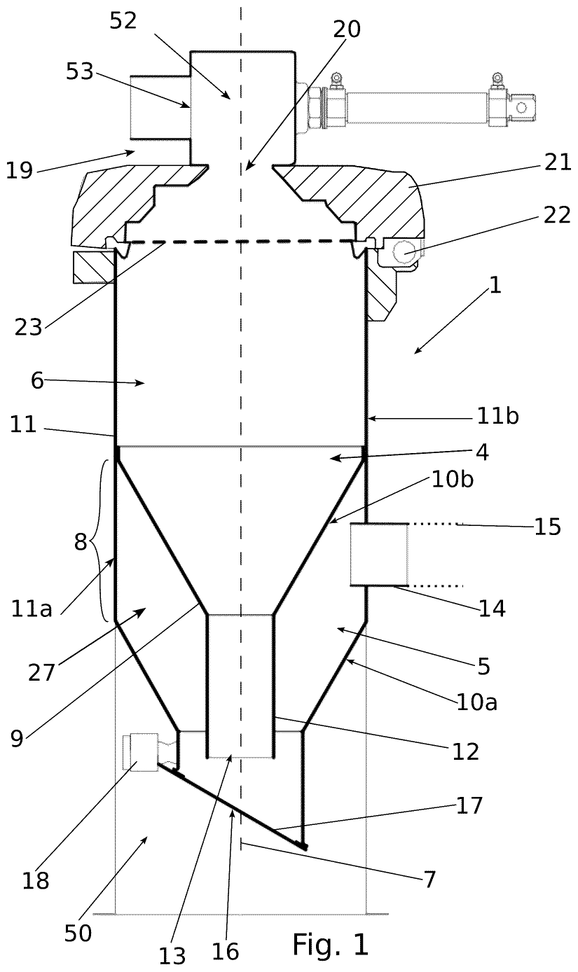

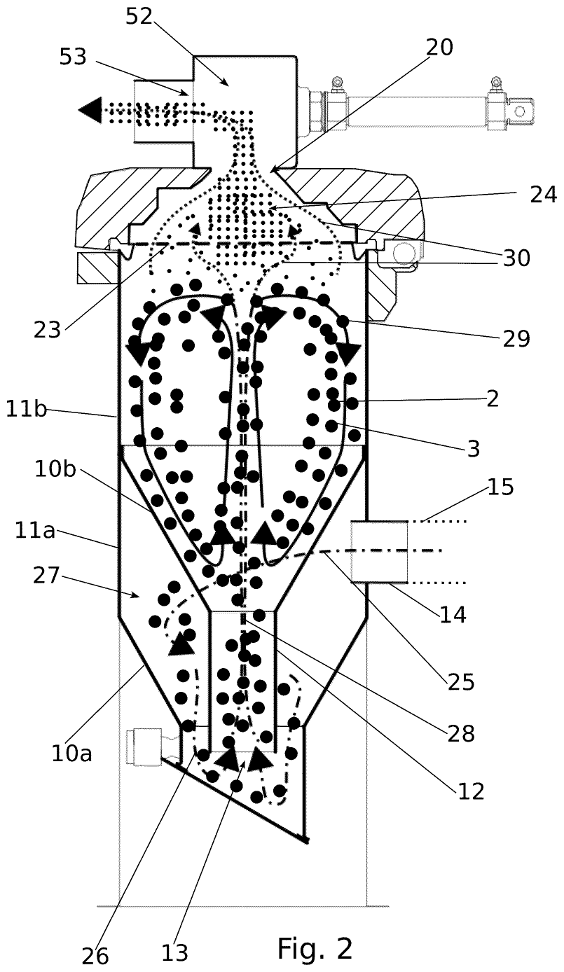

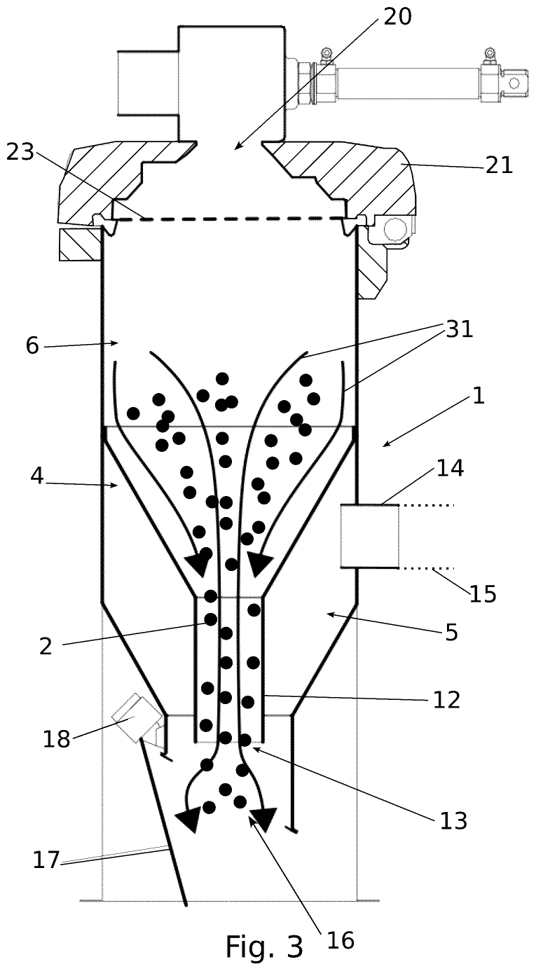

FIG. 1 shows a separating device 1 for cleaning contaminated bulk material 2 (see FIGS. 2 and 3). The bulk material 2 can be, for example, a recycled plastic material, referred to as recyclate 3. In particular, the bulk material is a plastic granulate. The separating device 1 comprises a cleaning chamber 4, which is divided into an inlet region 5 and a circulating region 6. In the illustration shown, the circulating region 6 is arranged at least partially above the inlet region 5. Viewed along the axis of symmetry 7, however, there is an overlap region 8 in which both the inlet region 5 and the circulating region 6 are arranged at the same height along the longitudinal axis 7. In the illustration shown, the axis of symmetry 7 also forms the longitudinal axis of the cleaning chamber 4. The inlet region 5 and the circulating region 6 are spatially separated from one another by a wall 9 with the exception of an inlet opening 13, which will be described in more detail below. The wall 9 may be designed to be removable. Both the inlet region 5 and the circulating region 6 each comprise a conically converging section 10a, 10b on the underside. The conically converging section 10b can form the wall 9. Above the conically converging sections 10a, 10b, the inlet region 5 and the circulating region 6 each preferably comprise straight wall sections 11a, 11b. The wall sections 11a, 11b are formed by the outer wall 11 of the cleaning chamber. The conically converging section 10b of the circulating region 6 opens into an inlet tube 12, an inlet opening 13 being provided on the underside of the inlet tube 12. Bulk material 2 can pass through the inlet opening 13 and the inlet tube 12 from the inlet region 5 into the circulating region 6 and vice versa.

The cleaning chamber 4 also comprises an inlet nozzle 14, which is arranged substantially perpendicular to the longitudinal axis 7 and opens into the inlet region 5 in the illustration shown. The inlet nozzle 14 may be connected to a reservoir (not shown) of contaminated bulk material 2 via a suction line 15, indicated by the dotted lines.

An outlet opening 16, which may be closed with a flap 17, is provided on the underside 50 of the cleaning chamber 4, i.e. also on the underside of the inlet region 5. The flap 17 may be opened and closed by means of a drive 18, for example, a hydraulic or pneumatic actuator or an electric motor. In an alternative embodiment, the flap 17 is actuated by gravity. In the illustration shown, the cross-sectional area of the outlet opening 16 is inclined relative to the longitudinal axis 7 of the cleaning chamber 4.

In the illustration shown, a suctioning-off opening 20, via which the cleaning chamber 4 can be connected to a suctioning-off device (not shown), is arranged on the upper side 19 of the cleaning chamber 4. The suctioning-off opening 20 opens into a deflection chamber 52. In the illustration shown, the suctioning-off opening 20 is arranged centrally, i.e. substantially centrally about the axis of symmetry 7. The suctioning-off opening 20 or, as in the example shown, an opening 53 of the deflection chamber 52 may also be designed as a connection for the suctioning-off device or for a tube or a pipe to the suctioning-off device.

In the illustration shown, the cleaning chamber 4 comprises a lockable lid 21, in which the suctioning-off opening 20 is formed. The lid 21 may be folded away via a hinge 22, thus opening the cleaning chamber 4. It is preferable if the lid can be opened without tools.

In the circulating region 6, a grid 23 is provided, which is oriented horizontally, i.e. perpendicular to the longitudinal axis 7, in the illustration shown. Of course, the grid 23 may also be oriented obliquely to the longitudinal axis 7. The grid 23 is configured to retain bulk material 2 in the circulating region 6, but to allow dust and fine particles to pass through. The grid 23 may preferably be replaceable without tools. In one example, the grid 23 has an opening width of 2 mm.

FIG. 2 and FIG. 3 show the separating device 1 during operation. The flow path of the bulk material 2 and the contaminant 24 is indicated by arrows 25, 26, 28, 29, 30, 31.

In a conveying and empty suction sequence, which together form a conveying phase, a certain amount of bulk material, typically in the range of 1 kg to 50 kg of contaminated bulk material, is suctioned through the suctioning-off opening 20 via the inlet nozzle 14. The empty suction sequence is an optional sequence that does not necessarily have to be provided, but is implemented in the exemplary embodiment shown. If no empty suction sequence is provided, the conveying phase is formed only by the conveying sequence. In particular, in the case of short lengths of the suction line 15, it is possible to dispense with an empty suction sequence. Due to the suction vacuum or the resulting volume flow, the contaminated bulk material 2 is first sucked into the inlet region 5 (arrow line 25). In the inlet region 5, the contaminated bulk material 2 is braked by contact with the sections 10a, 10b and 11a and sucked downwards in the direction of the inlet opening 13 (arrow line 26). Depending on the strength of the volume flow, the contaminated bulk material 2 flows one or more times around the inlet tube 12 and moves downward in the process. This movement, which can be described as a movement in the manner of a tapering screw thread, is favored by a channel 27 formed between the tapering sections 10a, 10b in the inlet region 5. Finally, the contaminated bulk material 2 passes via the inlet tube 12 into the circulating region 6 and is suctioned upwards (arrow line 28).

In the conveying sequence, only a certain amount of bulk material 2 is suctioned. After all or at least the majority of the bulk material 2 is received within the cleaning chamber 4, a fluid, preferably air, is suctioned through the inlet nozzle 14 in an empty suction sequence following the conveying sequence. This has two effects: On the one hand, residues of bulk material 2 in the suction line 15 and in the inlet nozzle 14 are sucked into the cleaning chamber 4. On the other hand, the subsequently flowing fluid forces the contaminated bulk material 2 into the circulating region 6, where it is circulated. The circulation also already takes place in the conveying sequence.

After the contaminated bulk material 2 has been sucked up through the inlet tube 12, it is pulled centrally in the direction of the suctioning-off opening 20. From there, it is displaced radially outward by subsequent bulk material 2 (arrow line 29), falls laterally downward, and is sucked from there, favored by the conically converging section 10b of the circulating region 6, back upward in the middle in the direction of the suction opening 20. The bulk material 2 is thus poured over. The grid 23 prevents the suctioning-off of bulk material 2, but allows the passage of contaminants. This process is called circulation. As a result of the circulation, contaminants 24, such as dust and fine particles 24, are released from the contaminated bulk material 2 and suctioned off through the grid 23 (arrow lines 30). The bulk material 2 is cleaned by the circulation and suctioning off.

After a certain period of time, the empty suction sequence and thus the conveying phase is ended by terminating or reducing the suction via the suctioning-off opening 20. The sequence following the conveying phase is referred to as the emptying sequence. In the emptying sequence, the bulk material 2 drops downward through the inlet tube 12 (arrow lines 31) into the inlet region 5 due to gravity, as shown in FIG. 3. By opening the flap 17, the cleaned bulk material 2 passes from the inlet region 5 through the outlet opening 16 to the outside. Additional suctioning off can promote the conveyance of the cleaned bulk material 2 through the outlet opening 16. After passing through the outlet opening 16, the cleaned bulk material 2 can be conveyed further into a further separating device (not shown) or directly or indirectly, for example via an intermediate storage, to a plastic processing machine (also not shown). The onward transport can take place through pipes or tubes, in which the cleaned bulk material is preferably suctioned.

It is also possible for a plurality of separating devices 1 to be arranged and operated in parallel in order to clean contaminated bulk material 2 using the method according to the invention.

1. A method for cleaning contaminated bulk material, in a separating device with a cleaning chamber, comprising the following steps:
suctioning the contaminated bulk material via an inlet nozzle of the separating device and thereby conveying the contaminated bulk material into an inlet region of the cleaning chamber during a conveying sequence, wherein the conveying sequence forms a conveying phase; and
discharging the cleaned bulk material through an outlet opening during an emptying sequence after completion of the conveying phase,
wherein the contaminated bulk material is conveyed from the inlet region into a circulating region of the cleaning chamber via suctioning during the conveying phase and is continuously circulated in the circulating region up to the emptying sequence via suctioning and is thereby cleaned, wherein contaminants which detach from the contaminated bulk material are suctioned off from the circulating region via suctioning of the contaminated bulk material via an suctioning-off opening during the conveying phase.

2. The method according to claim 1, wherein the suctioning-off opening is provided on an upper side of the cleaning chamber and a suctioning-off device is connected to the suctioning-off opening, the suctioning-off device suctioning the bulk material during the conveying phase and suctioning off the contaminants.

3. The method according to claim 1, wherein the outlet opening is arranged on an underside of the cleaning chamber and the cleaned bulk material falls downward through the outlet opening due to gravity in the emptying sequence.

4. The method according to claim 1, wherein the contaminated bulk material is braked in the inlet region by an inner wall of the inlet region after suctioning in the conveying sequence.

5. The method according to claim 1, wherein the circulating region comprises an inlet opening arranged below the inlet nozzle, so that the bulk material is initially sucked downwards to the inlet opening in the conveying phase in the inlet region and is then sucked upwards into the circulating region.

6. The method according to claim 1, wherein the contaminated bulk material is circulated in the circulating region by the contaminated bulk material being suctioned from above, being displaced radially outwards by subsequent contaminated bulk material, falling downwards and then being suctioned again from above.

7. The method according to claim 1, wherein the conveying phase and the emptying sequence form a cleaning cycle and a plurality of cleaning cycles are carried out in succession.

8. A method for producing a plastic product, comprising the following steps:
a) cleaning contaminated bulk material with a method for cleaning contaminated bulk material according to claim 1;
b) feeding the cleaned bulk material to a plastic processing machine; and
c) producing a plastic product with the plastic processing machine.

9. A separating device for cleaning contaminated bulk material, comprising:
a cleaning chamber having an inlet region;
an inlet nozzle leading into the inlet region; and
an outlet opening,
wherein the separating device is configured to be operated in a conveying sequence in which the contaminated bulk material is conveyed through the inlet nozzle into the inlet region via suctioning, and in an emptying sequence in which cleaned bulk material is discharged through the outlet opening, wherein the conveying sequence forms a conveying phase,
wherein
the cleaning chamber comprises a circulating region, and the inlet region and the circulating region are arranged and configured in such a way that the contaminated bulk material is conveyed from the inlet region into the circulating region via suctioning during the conveying phase during operation of the separating device and is continuously circulated in the circulating region up to the emptying sequence via suctioning and is thereby cleaned, wherein contaminants which detach from the contaminated bulk material can be suctioned off from the circulating region via suctioning the contaminated bulk material via a suctioning-off opening during the conveying phase.

10. The separating device according to claim 9, wherein the suctioning-off opening is arranged on an upper side of the cleaning chamber, and is designed as a connection for a suctioning-off device.

11. The separating device according to claim 9, wherein a grid is provided in the circulating region.

12. The separating device according to claim 11, wherein the grid comprises an opening width of 0.2 mm to 5 mm.

13. The separating device according to claim 9, wherein the circulating region comprises an inlet opening on the underside, through which the contaminated bulk material passes into the circulating region, the inlet opening being arranged below the inlet nozzle.

14. The separating device according to claim 13, wherein the circulating region is adjoined by an inlet tube, which comprises an inlet opening arranged at the end of the inlet tube, facing the underside of the cleaning chamber.

15. The separating device according to claim 13, wherein the cross-sectional area of the inlet opening is between 50% and 130% of the cross-sectional area of the inlet nozzle.

16. The separating device according to claim 9, wherein, viewed in the cross-section of the cleaning chamber and along an axis of symmetry of the cleaning chamber, the inlet region and the circulating region at least partially overlap.

17. The separating device according to claim 9, wherein, viewed in the cross-section of the cleaning chamber, the inlet region and the circulating region each comprise a conically converging section, and a channel for the contaminated bulk material is formed in the inlet region between the conically converging sections of the inlet region and the circulating region.

18. The separating device according to claim 17, wherein, as viewed in the cross-section of the cleaning chamber, the inlet nozzle is arranged at the level of the conically converging section of the circulating region.

19. A system for producing a plastic product, comprising:
a suction device;
the separating device according to claim 9, connected to the suction device; and
a plastic processing machine, which is connected to the separating device.

20. The method according to claim 1, further comprising:
suctioning a fluid through the inlet nozzle during an empty suction sequence following the conveying sequence to empty the inlet nozzle and a suction line of possible residues of the contaminated bulk material, wherein the conveying phase further comprises the optional empty suction sequence.
